(19) United States
(12) Patent Application Publication
(10) Pub. No.: US 2012/0151267 A1
(43) Pub. Date: Jun. 14, 2012

(54) SYSTEM FOR EXTENDING USE OF A DATA ADDRESS BREAK POINT REGISTER TO IMPLEMENT MULTIPLE WATCH POINTS

(75) Inventors: Rajbir Bhattacharjee, Laitumkhrah (IN); Rajeev Mishra, Bangalore (IN); Avanish K. Ojha, Bangalore (IN); Muthulakshmi P. Srinivasan, Bangalore (IN)

(73) Assignee: INTERNATIONAL BUSINESS MACHINES CORPORATION, Armonk, NY (US)

(21) Appl. No.: 12/964,352

(22) Filed: Dec. 9, 2010

(51) Int. Cl. G06F 11/36

(52) U.S. Cl. 714/38.1; 714/E11.208

(57) ABSTRACT

A method is provided for implementing multiple watchpoints or a watchpoint that is greater than one word in length. The method comprises a debugger receiving a watchpoint from a user, wherein the watchpoint identifies a portion of memory to be watched. The debugger then sends a read trap or write trap flag, for example READ_TRAP or WRITE_TRAP, to a memory protection module of an operating system identifying the portion of memory to be watched. A read or write operation is allowed on the watched portion of memory, but, after completion of the read or write operation, an exception signal is sent that indicates that the read or write operation occurred on the watched portion of memory. The debugger then provides output to a user regarding the exception.

### BACKGROUND

1. Field of the Invention

The present invention relates to implementing a watchpoint in a debugging program.

2. Background of the Related Art

The complexity and volume of software code has increased along with the increasing speed of computer processors and the expanding amount of memory available in computer systems. This increasing complexity and volume of software code tends to complicate the process of debugging software code to identify and remove errors and other problems that may occur during the operation of the software. Accordingly, writing the software for a new application program is greatly facilitated by the use of a debugging program (or simply “debugger”).

One of the tools implemented in a debugger is referred to as a breakpoint. A breakpoint is an intentional stopping or pausing place in an application program that is included in the software code for the specific purpose of determining how a program is being executed. A breakpoint may also be triggered by the occurrence of one or more conditions, such as the reading, writing, or modification of a specific location or address in memory. Such a conditional breakpoint may be referred to as a watchpoint.

Watchpoints are implemented in the debugger by storing a memory address in the data address breakpoint register (DABR). When the data in the memory address is modified, the execution of the program is interrupted. However, this method is suffers the limitation that, at any given point in time, only one word of memory can be watched. The term “word” in this context is a natural unit of data used by a particular computer design. The word size or word length is the number of bits in a word. For example, modern computers will typically have a word size of 16, 32 or 64 bits.

DBX is a Unix-based debugger that provides debugging for programs written in C, C++, Pascal, and Fortran programming languages. DBX provides the useful capability of executing a program one line or instruction at a time. Accordingly, DBX can get around the one-word watchpoint limitation by pausing execution of the program after every instruction, and then comparing the previous value stored at the memory address with the current value stored at the same memory address. If the current value does not match the previous value, then a mismatch is reported. However, if the normal execution of the program caused the same value to be written over the previous value, DBX will fail to detect that anything has been written to the memory address and the watchpoint will be missed.

### BRIEF SUMMARY

One embodiment of the present invention provides a method, comprising: a debugger receiving a watchpoint from a user, wherein the watchpoint identifies a portion of memory to be watched; the debugger sending a read trap or write trap flag to a memory protection module of an operating system identifying the portion of memory to be watched; allowing a read or write operation on the watched portion of memory; after completion of the read or write operation, sending an exception signal that indicates that the read or write operation occurred on the watched portion of memory; and the debugger providing output to a user regarding the exception.

Another embodiment of the present invention provides a computer program product including computer usable program code embodied on a computer usable storage medium. The computer program product comprises computer usable program code for receiving a watchpoint from a user, wherein the watchpoint identifies a portion of memory to be watched; computer usable program code for sending a read trap or write trap flag to a memory protection module of an operating system identifying the portion of memory to be watched; computer usable program code for allowing a read or write operation on the watched portion of memory; computer usable program code for, after completion of the read or write operation, sending an exception signal that indicates that the read or write operation occurred on the watched portion of memory; and computer usable program code for providing output to a user regarding the exception.

### BRIEF DESCRIPTION OF THE SEVERAL VIEWS OF THE DRAWINGS

FIG. 1 is a schematic diagram of a system in accordance with one embodiment of the invention.

FIG. 2 is a flowchart of a method of implementing a watchpoint.

### DETAILED DESCRIPTION

One embodiment of the present invention provides a method of implementing multiple watchpoints or a watchpoint that is greater than one word in length. The method comprises a debugger receiving a watchpoint from a user, wherein the watchpoint identifies a portion of memory to be watched. The debugger then sends a read trap or write trap flag, for example READ_TRAP or WRITE_TRAP, to a memory protection module of an operating system identifying the portion of memory to be watched. A read or write operation is allowed on the watched portion of memory, but, after completion of the read or write operation, an exception signal is sent that indicates that the read or write operation occurred on the watched portion of memory. The debugger then provides output to a user regarding the exception.

In any particular embodiment, the method may include only a read trap, one a write trap, or both a read trap and a write trap. An exception is raised in response to a read operation being directed to an address for which a read trap is set, or in response to a write operation being directed to an address for which a write trap is set.

In another embodiment of the method, the debugger sends the read trap or write trap flag to the memory protection module in a ptrace system call. The ptrace system call allows the debugger application to control one or more aspects of the memory protection module, such as causing the memory protection module to provide an extra attribute to a page of memory including the watchpoint. Preferably, the extra attribute indicates whether the hardware should trap on a read or write operation. Still further, the ptrace system call may include a process identification (ID) of the debugger and a process ID of a thread whose memory is being watched. Providing these process IDs in the ptrace system call enables control to be subsequently returned to the appropriate debugger and identify the thread to which the exception relates.

In a further embodiment, a hardware trap will raise a trap and the thread will enter a trap handler in response to a read or a write operation occurring on a page that includes the watchpoint, but will allow the read or write operation to proceed. The trap handler gives control to the debugger, such that the debugger may examine the thread to determine whether the thread is attempting a read or write operation to an address in the watched portion of memory. The debugger may prompt a user for instructions in response to the debugger determining that the thread is attempting a read or write operation to an address in the watched portion of memory. Alternatively, the debugger may resume debugging the thread in response to the debugger determining that the thread is attempting a read or write operation to an address other than the watched portion of memory. This later situation is possible because the memory protection module sets a trap on a block-by-block basis, whereas the watchpoint addresses may cover only a portion of a block or portions of more than one block.

Although the invention is not limited by the size of the watchpoint, embodiments of the invention enable a watchpoint having a size greater than one word. Specifically, a watchpoint may be identified within the data address breakpoint register by a starting address (A) and a size (N). The memory protection module then sets the appropriate traps on the one or more blocks of memory that contain the range of addresses from the starting address and ending address that is determined by the size (N) of the watchpoint.

In another embodiment, the exception signal is sent to the debugger, and the debugger provides output to the user regarding the exception. Alternatively, the exception signal is sent to a thread that caused the exception, and the thread provides output to the user regarding the exception. Optionally, the exception is caught by a virtual memory manager, and the exception signal is sent by the virtual memory manager.

In a still further embodiment, a watchpoint may be implemented for use in debug-malloc. Accordingly, debug-malloc will set read trap or write trap flags on memory that it allocates. Then, if there is a read or write to the memory allocated, then an exception is sent to the debug-malloc library to handle the exception and determine if there is a memory overrun or underrun. If such an overrun or underrun is found, the debug-malloc library can then handle the situation accordingly, such as issue a prompt or output to a user without dumping. This approach may be very helpful when debugging legacy code which often includes a lot of memory overwrites, and often the typical debug malloc (without the present invention) will dump much before the actual problem in the code has been reached.

Yet another embodiment provides a computer program product including computer usable program code embodied on a computer usable storage medium for implementing a watchpoint. The computer program product comprises computer usable program code for receiving a watchpoint from a user, wherein the watchpoint identifies a portion of memory to be watched; computer usable program code for sending a read trap or write trap flag to a memory protection module of an operating system identifying the portion of memory to be watched; computer usable program code for allowing a read or write operation on the watched portion of memory; computer usable program code for, after completion of the read or write operation, sending an exception signal that indicates that the read or write operation occurred on the watched portion of memory; and computer usable program code for providing output to a user regarding the exception. Optionally, the computer program product may include additional computer usable program code to perform other aspects of the methods described above.

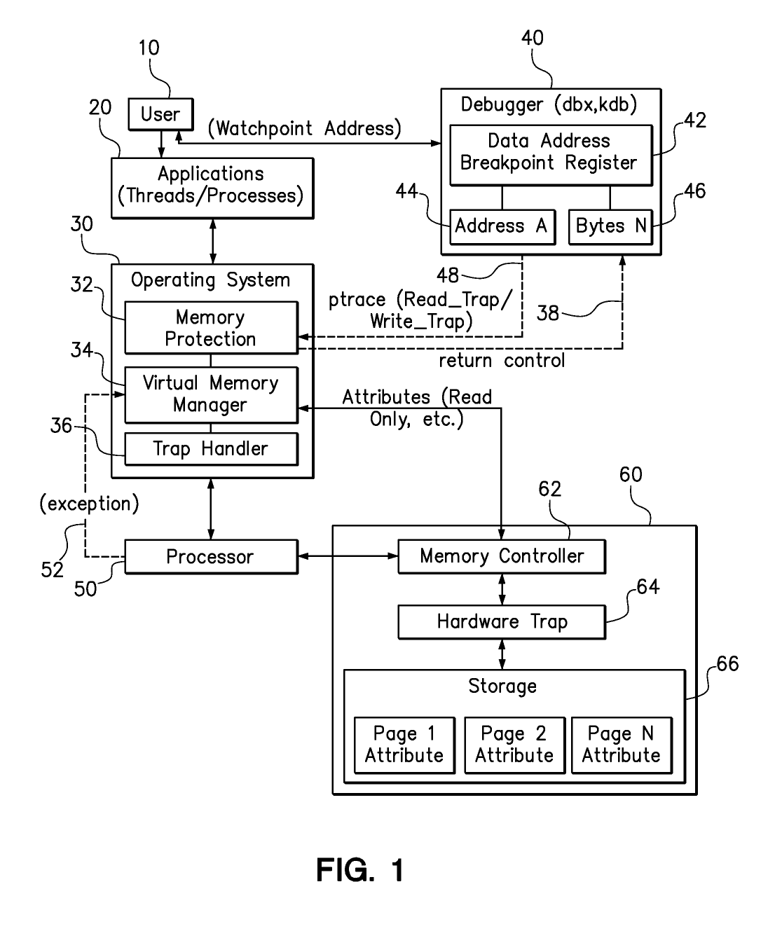

FIG. 1 is a schematic diagram of a computer system in accordance with one embodiment of the invention. A user 10 may interact with applications 20, operating system 30 and a debugger 40. It should be understood that the operation of the applications, operating system and debugger rely upon various hardware components of the computer system. The computer system hardware includes a processor 50 and a memory system 60, which includes a memory controller 62, a hardware trap 64, and a storage system 66 such as RAM, a hard disk drive, flash memory and the like. It will be understood that other hardware components may be present in a functioning computer system.

The user 10 may input watchpoint address to the debugger 40, which stores the watchpoint in a data address breakpoint register 42. Optionally, the watchpoint is longer than a single word and may be stored as a starting address A (stored in a first register 44) and a byte length N (stored in a second register 46) following the starting address A. The debugger 40 implements the watchpoint by sending a ptrace system call (See signal 48) to a memory protection module 32 of the operating system 30. The ptrace system call includes the relevant read-trap or write-trap (or both), including the watchpoint address, and preferably also including an ID of the debugger 40 and an ID of the application or thread 20 that is being debugged. The ptrace system call instructs the memory protection module 32 to set the requested traps on memory at the watchpoint address range.

The memory protection module 32 cooperates with the virtual memory manager 34 to send additional attributes, such as a read-only attribute and/or a write-only attribute, to the memory system 60. The memory controller 62 receives the attributes and associated those attributes with the pages or block of the memory storage 66 that include any portion of the watchpoint address range.

The hardware trap 64 will trap if a read or a write occurs on a page or memory having the special read-only or write-only attribute. However, the hardware trap will allow the read or write instruction to proceed. The trap handler 36 will then decide whether the load/store (read/write) happened in the word(s) being watched in accordance with the watchpoint address range.

The processor 50 includes support for these special read trap and write trap flags, and allows processes to read and write to memory having a read-only or write-only attribute, but will then raise an exception (see signal 52). This exception will be caught by the virtual memory manager (VMM) 34. If the trap handler 36 determines that the trapped read/write did not occur within the watchpoint address range, then the VMM 34 will ignore the exception. However, if the trap handler 36 determines that the trapped read/write occurred within the watchpoint address range, then the VMM 34 will act upon the exception and cause the memory protection module 32 to send a signal (see signal 38) to the debugger 40 according to the debugger ID in the ptrace system call 48 that was responsible for setting the trap in the first place. The debugger 40 may then notify the user that a read or write has occurred within the watchpoint address range and prompt the user for action.

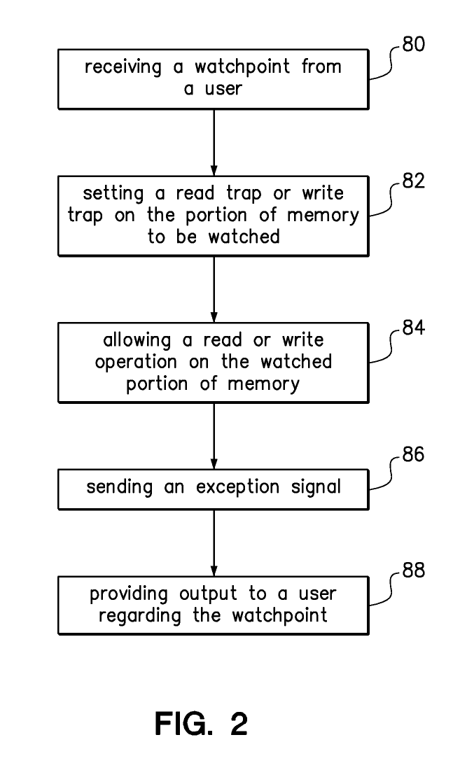

FIG. 2 is a flowchart of a method of implementing a watchpoint. In step 80, a watchpoint is received from a user. Typically, the watchpoint is received by a debugger, wherein the watchpoint identifies a portion of memory to be watched. In step 82, a read trap or write trap is set on the portion of memory to be watched. Such traps may be implemented by a memory protection module of an operating system. A read or write operation on the watched portion of memory is allowed in step 84. After completion of the read or write operation, an exception signal is sent in step 86. In step 88, output is provided to a user regarding the exception.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a debugger receiving a watchpoint from a user, wherein the watchpoint identifies a portion of memory to be watched;
the debugger sending a read trap or write trap flag to a memory protection module of an operating system identifying the portion of memory to be watched;
allowing a read or write operation on the watched portion of memory;
after completion of the read or write operation, sending an exception signal that indicates that the read or write operation occurred on the watched portion of memory; and
the debugger providing output to a user regarding the exception.

2. The method of claim 1, wherein the debugger sends the read trap or write trap flag in a ptrace system call.

3. The method of claim 2, wherein the ptrace system call includes a process id of the debugger and a process id of a thread whose memory is being watched.

4. The method of claim 1, wherein the watchpoint has a size greater than one word.

5. The method of claim 4, wherein the watchpoint is identified by a starting address and a size.

6. The method of claim 1, wherein the exception signal is sent to the debugger, and the debugger provides output to the user regarding the exception.

7. The method of claim 1, wherein the exception signal is sent to a thread that caused the exception, and the thread provides output to the user regarding the exception.

8. The method of claim 1, wherein the exception is caught by a virtual memory manager, and the exception signal is sent by the virtual memory manager.

9. The method of claim 1, further comprising:
providing an extra attribute to a page of memory including the watchpoint, wherein the extra attribute indicates whether the hardware should trap on a read or write operation.

10. The method of claim 9, wherein the extra attribute is set by a memory protection module.

11. The method of claim 9, wherein a hardware trap will raise a trap and the thread will enter a trap handler if a read or a write operation occurs on a page that includes the watchpoint, but allow the read or write operation to proceed.

12. The method of claim 11, further comprising:
the trap handler giving control to the debugger; and
the debugger examining the process to determine whether the process is attempting a read or write operation to an address in the watched portion of memory.

13. The method of claim 12, further comprising:
the debugger prompting a user for instructions in response to the debugger determining that the thread is attempting a read or write operation to an address in the watched portion of memory.

14. The method of claim 13, further comprising:
the debugger resumes debugging the process in response to the debugger determining that the thread is attempting a read or write operation to an address other than the watched portion of memory.

15. The method of claim 1, wherein the debugger is debug-malloc.

16. The method of claim 15, further comprising:
debug-malloc generating a warning for an invalid memory access without dumping.

17. The method of claim 16, wherein the warning is output to a user.

18. A computer program product including computer usable program code embodied on a computer usable storage medium, the computer program product comprising:
computer usable program code for receiving a watchpoint from a user, wherein the watchpoint identifies a portion of memory to be watched;
computer usable program code for sending a read trap or write trap flag to a memory protection module of an operating system identifying the portion of memory to be watched;
computer usable program code for allowing a read or write operation on the watched portion of memory;
computer usable program code for, after completion of the read or write operation, sending an exception signal that indicates that the read or write operation occurred on the watched portion of memory; and
computer usable program code for providing output to a user regarding the exception.

19. The computer program product of claim 18, wherein the read trap or write trap flag is sent to the memory protection module in a ptrace system call.

20. The computer program product of claim 19, wherein the ptrace system call includes a process id of a debugger and a process id of a thread whose memory is being watched.

21. The computer program product of claim 18, wherein the watchpoint has a size greater than one word.
